(19) United States
(12) Patent Application Publication
(10) Pub. No.: US 2023/0349234 A1
(43) Pub. Date: Nov. 2, 2023

(54) TELESCOPING DEVICE FOR CLIMBING ON A ROOF

(71) Applicant: Brian Nicholas Garlock, Raleigh, NC (US)

(72) Inventor: Brian Nicholas Garlock, Raleigh, NC (US)

(21) Appl. No.: 18/308,869

(22) Filed: Apr. 28, 2023

Related U.S. Application Data
(60) Provisional application No. 63/363,764, filed on Apr. 28, 2022.

(51) Int. Cl. E06C 1/38; E06C 1/34; E06C 1/36; E06C 7/48; E06C 1/397

(52) U.S. Cl. CPC E06C 1/381; E06C 1/345; E06C 1/36; E06C 7/488; E06C 1/397

(57) ABSTRACT

A handheld, lightweight pole that telescopically extends a substantial length that terminates at a hook. The hook allows the user to attach the pole securely to the ridge. A plurality of rungs is spaced along the pole, wherein each rung acts as a step or handle to help the user climb safely. Each hung may be selectively positioned along the pole.

### CROSS-REFERENCE TO RELATED APPLICATION

This application claims the benefit of priority of U.S. provisional application No. 63/363,764, filed Apr. 28, 2022 the contents of which are herein incorporated by reference.

### BACKGROUND OF THE INVENTION

The present invention relates to climbing on roofs and, more particularly, to a telescoping pole with a detachable hook for climbing roofs.

When climbing a steep roof, it is often difficult to reach the ridge, without the use of scaffolding or ropes. The former is very safe, but takes a long time to set up, requires a large vehicle to transport due to its bulk and weight, and takes up a lot of storage space even when disassembled; the latter is difficult to use and looks unprofessional. This would become much easier if you had a device that allows you to climb up the roof like a ladder. However, prior to the present invention, no such devices existed.

There are many problems with existing solutions. The problems with a product referred to as “the goat” is the multiple pieces involved and multiple pins holding each section can easily be lost. A product known as “ridge pro” requires a painter's pole which does not collapse small enough to be hand-held. While these other systems are functionally sound, they are not convenient and easy to use.

As can be seen, there is a need for a lightweight telescoping roof climbing pole that can be carried in a small car.

### SUMMARY OF THE INVENTION

In one aspect of the present invention, a telescoping climbing device includes a plurality of pole segments movable between a collapsed condition and an extended condition; a rung operatively associated with each pole segment; and a hook attached to a distal-most pole segment of the plurality of pole segments.

In another aspect of the present invention, telescoping climbing device further includes; a hook support laterally extending from a terminus of the hook for stabilizing the hook on an inclined surface; a roller rotatably connected to a rear portion hook so that the roller rolls in a direction parallel with a longitudinal axis of the plurality of pole segments; a rung cantilevering from each pole segment; a strap along a lateral face of each rung; a release associated with each pole segment that moves the pole segment between an slidably engagement and a locked engagement with an adjacent pole segment; and a foot coupled to a proximal-most pole segment of the plurality of pole segments.

In yet another aspect of the present invention, a method of climbing an inclined roof includes the following: rolling, by way of the roller, the above-mentioned telescoping climbing device, in the extended condition, up the inclined roof until the hook is adjacent a ridge of the inclined roof; rotating the telescoping climbing device approximately 180 degrees so that the hook engages the ridge; and engaging the plurality of rungs in a climbing motion.

These and other features, aspects and advantages of the present invention will become better understood with reference to the following drawings, description, and claims.

### BRIEF DESCRIPTION OF THE DRAWINGS

FIG. 1 is a perspective view of an exemplary embodiment of the present invention, shown in an extended configuration.

FIG. 2 is a detailed perspective view of an exemplary embodiment of the present invention, illustrating depression of a release button 16 to move the pole to the collapsed configuration.

FIG. 3 is an exploded perspective view of an exemplary embodiment of the present invention, shown in the collapsed configuration.

FIG. 4 is a side elevation view of an exemplary embodiment of the present invention, shown in a used condition engaging the ridge 30 of a roof.

FIG. 5 is a perspective view of an exemplary embodiment of the present invention, shown in the used condition engaging the ridge 30.

FIG. 6 is a side elevation view of an exemplary embodiment of the present invention, shown in the used condition engaging a tree 32.

FIG. 7 is a top perspective view of an exemplary embodiment of the present invention, shown in an extended configuration.

FIG. 8 is a bottom perspective view of an exemplary embodiment of the present invention, shown in an extended configuration.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a handheld, lightweight device that telescopically extends a substantial length (e.g., up to 18 feet) so a user can access the ridge of a roof. A hook is provided at the end, which allows the user to attach the device securely to the ridge. Each rung of the device acts as a step or handle to help the user climb safely.

The prior art products described previously are bulky and not easy to handle. They either require multiple pieces to link together or a long bulky contraption with no handles.

The present invention allows someone to easily transport the entire device, no matter the size of vehicle. It also allows the user to customize the length while holding all pieces at the same time on the roof. It enables the user to easily carry all pieces up a ladder to the eave.

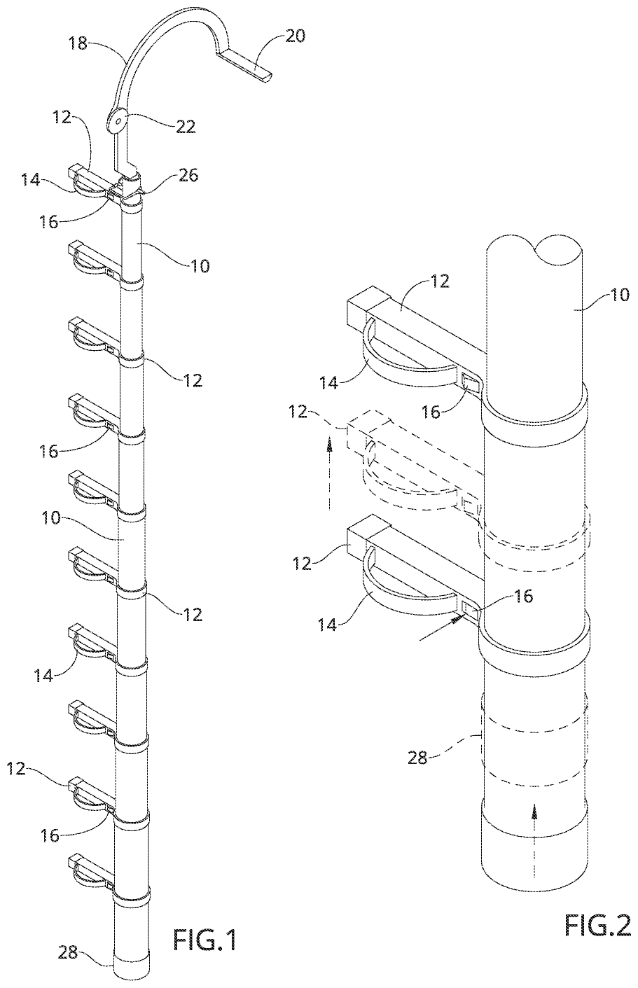

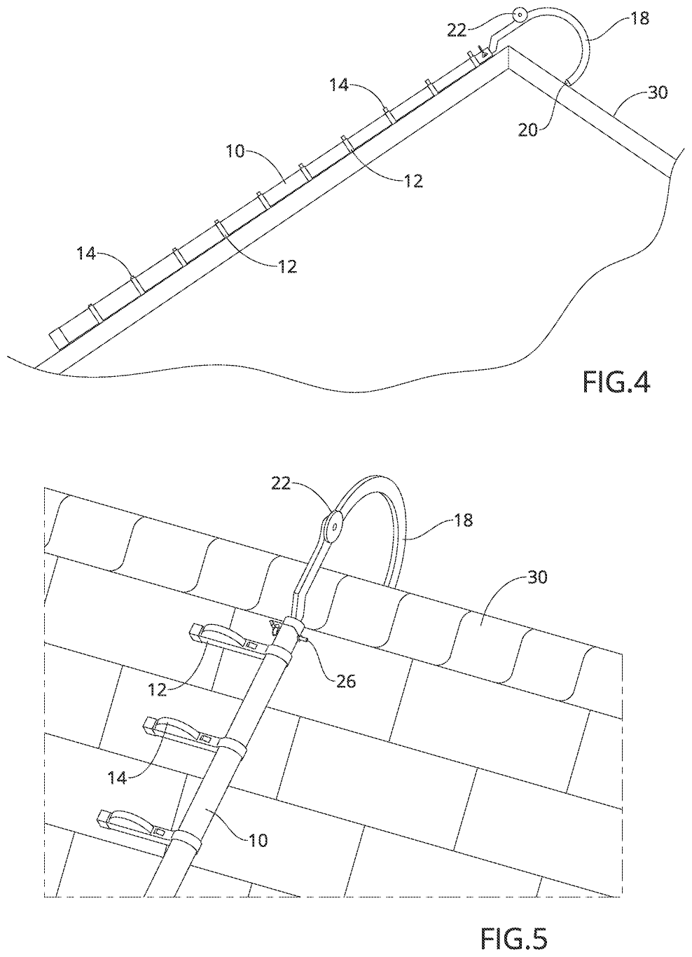

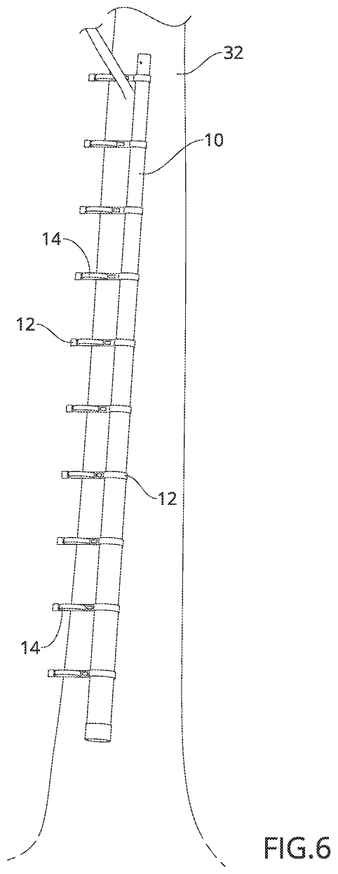

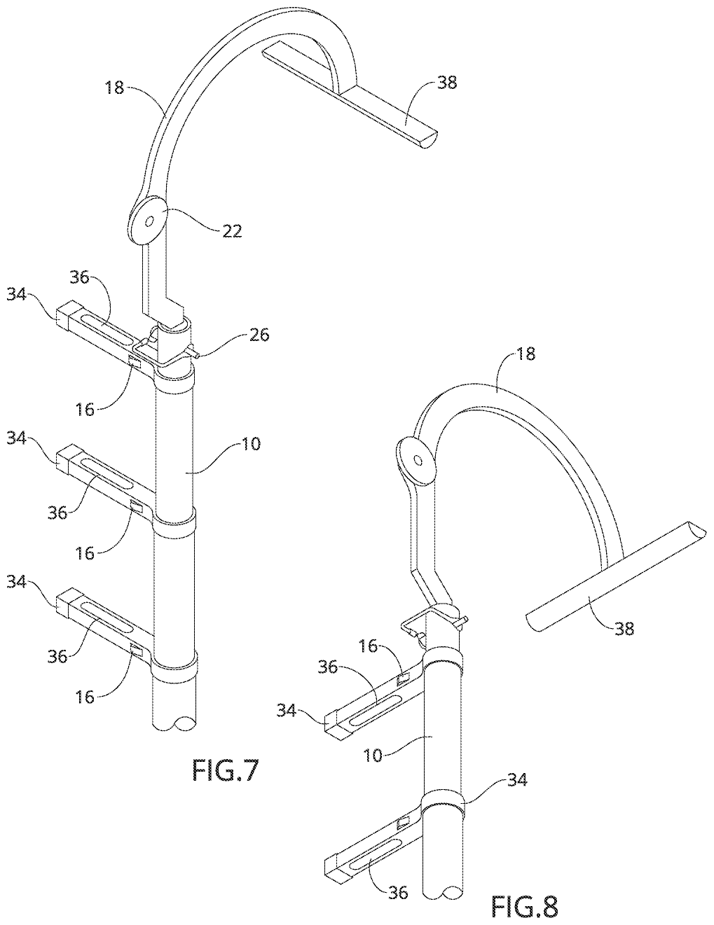

Referring now to FIGS. 1 through 8, a roof climbing device 100 includes a telescoping pole 10, a plurality of rungs 12, and a hook 18. In certain embodiments, the telescoping pole 10 may include of a plurality of pole segments telescopically coupled to one another. Each segment may be cylindrical and have a uniform diameter so that it nests within an adjacent proximal segment. In other embodiments, each pole segments may be tapered through their length.

In some embodiments, each pole segment has a rung 12 extending radially outwardly therefrom. In other embodiment, a plurality of rungs 12 may be associated with one telescopic segment. Each rung may be generally elongated, having a radially extending length at least three times its cross section width or height. In some embodiments, the rung may be cuboid; along a lateral face of the cuboid a loop 14 is provided for grasping or being handled. In other embodiments, the rung 34 may provide an aperture 36 for users to attain a grip, and so loop 14 would not be present.

In some embodiments, each segment is provided with a connector, such as a push pin connection, such that it can be locked in an extended position when it is fully extended. To permit collapsing, the push pin connection is simply depressed and the segment 11A can collapse. In other embodiments, each rung 12 provides a release button 16 which toggled between a locked engagement with the pole 10 and a slidable disengagement thereof for selectively moving and locking the associated rung 12 relative the pole 10.

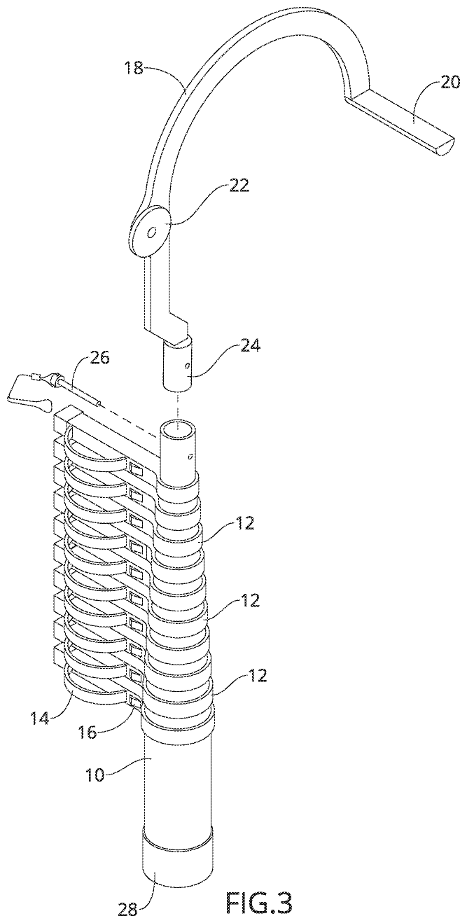

The hook 18 is arcuate in form and designed to hook around the ridge 30 of a roof. As shown in FIG. 3, the hook 18 has a support portion 20 extending laterally in one or both directions from an end of the hook 18 to stabilize the device 100, in use. Though it should be noted that in some embodiments the support portion 20 can be connected at its center to the end of the hook 18 (i.e., where the end of the hook 18 “T”-s into the support portion 38) or anywhere along the support portion 20. Further, the hook 18 may include a wheel or roller 22 on a backside thereof, which is used to help roll the device 100 up the roof to get from the eave to the ridge 30. In certain embodiments, a hook post 24 is provided so that the hook 18 may be detachably connected to an uppermost pole segment. Thus, the device 100 can be made even more portable by collapsing to a smaller size. This hook post 24 also prevents the hook 18 from spinning when the device 100 is rotated from using the wheel 22 to using the support portion 20 on the ridge 30.

The hook post 24 may be embodied as detachable or permanent, depending on the desired final configuration. In some embodiments, a clevis pin 26 operatively associates with a hole in the hook post 24, making it detachable. Further, the attachment of the hook 18 may be provided in a fixed position or foldable. In embodiments where the hook 18 is foldable, the pin for attachment is permanently affixed and the hook can fold and lock into place.

At the opposite end of the telescoping pole 10, relative to the hook 18, may be a footing 18 for protecting the end of the device 100 that is against a supporting surface.

In use, the telescoping device 100 extends segment by segment and locks in place at each segment with the push pin connection. Each push pin locks in place when each segment reaches its maximum length due to a hole that the pin finds internally. As mentioned, the hook 18 has a lateral support portion 20 at the end which presses against the roof, allowing for stability. The hook is connected to the pole 10 at an upper end thereof with the use of a pin connection 26. The wheel 22 on the back side of the hook 18 allows it to roll up the roof without dragging or causing damage. The pin 26 also allows the hook 18 to be selectively secured and detached to the telescoping pole 10.

Connecting the pole 10 to the hook 18 with a pin 26 requires extending each segment of the pole 10 to its maximum length which allows the corresponding holes to connect with the push pin connections. Collapsing the telescoping pole 10 requires pressing the push pin connections to release the pin from their corresponding holes.

Each rung provides an eyelet through which its respective cylindrical segment is received. In embodiments where the telescopic pole 10 is a series of successively smaller segments, the proximal segment, of two adjacent segments, has a greater diameter than its distal counterpart. Thereby this difference is diameter defines a shelf on which the eyelet of the rung 12 associated with distal segment is supported.

In an exemplary embodiment, the device 100 may be used as follows. First, connect the hook 18 to the pole 10 with the pin 26. Next, extend each section of the pole 10 until the pin connections lock in place. A user should ensure to extend it up the ridge while the open side of the hook is facing away from the roof, allowing the wheel to roll on the roof. Once the device reaches the ridge, rotate it approximately 180 degrees to engage the hook side with the roof ridge. It will be appreciated that the present invention may also be used to climb trees 32 or anything that the hook may be able to connect to.

In an exemplary embodiment, the device may be made and assembled as described above and as follows. Any appropriate manufacturing technique may be selected from known options such that the described functionality is achieved. First, a telescoping pole is formed. Rungs are coupled to each segment of the pole. The hook is formed with a support section and a wheel rotatably attached thereto. A hole should be formed at a top of the telescoping pole to couple the hook to the pole. In certain embodiments, the hook may be formed from forged aluminum.

The elements most critical to the present invention are the telescoping pole and the hook. The pin connection could be replaced by creating a screw on connection between the pole and the hook. The wheel on the back of the hook could be removed entirely, which would still allow adequate function but could potentially damage the roof in the process.

While one or more preferred embodiments are disclosed, many other implementations will occur to one of ordinary skill in the art and are all within the scope of the invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Other arrangements, methods, modifications, and substitutions by one of ordinary skill in the art are therefore also considered to be within the scope of the present invention, which is not to be limited except by the claims directed to the present invention.

As used in this application, the term “about” or “approximately” refers to a range of values within plus or minus 10% of the specified number. And the term “substantially” refers to up to 80% or more of an entirety.

While apparatuses and methods are described in terms of “comprising,” “containing,” or “including” various components or steps, the apparatuses and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted. Moreover, the use of directional terms such as above, below, upper, lower, upward, downward, left, right, and the like are used in relation to the illustrative embodiments as they are depicted in the figures, the upward or upper direction being toward the top of the corresponding figure and the downward or lower direction being toward the bottom of the corresponding figure.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the present invention.

What is claimed is:

1. A telescoping climbing device comprising:
a plurality of pole segments movable between a collapsed condition and an extended condition;
a rung operatively associated with each pole segment; and
a hook attached to a distal-most pole segment of the plurality of pole segments.

2. The telescoping climbing device of claim 1, wherein each rung cantilevers from its respective pole segment.

3. The telescoping climbing device of claim 2, further comprising a strap along a lateral face of each rung.

4. The telescoping climbing device of claim 2, further comprising a release associated with each pole segment that moves the pole segment between a slidably engagement and a locked engagement with an adjacent pole segment.

5. The telescoping climbing device of claim 2, further comprising a hook support laterally extending from a terminus of the hook for stabilizing the hook on an inclined surface.

6. The telescoping climbing device of claim 2, further comprising a roller rotatably connected to a rear portion, opposite a terminus, of the hook so that the roller rolls in a direction parallel with a longitudinal axis of the plurality of pole segments.

7. The telescoping climbing device of claim 2, further comprising a hook post removably connecting the hook to said distal-most pole segment.

8. The telescoping climbing device of claim 2, further comprising a foot coupled to a proximal-most pole segment of the plurality of pole segments.

9. A telescoping climbing device comprising:
a plurality of pole segments movable between a collapsed condition and an extended condition;
a hook removably attached to a distal-most pole segment of the plurality of pole segments;
a hook support laterally extending from a terminus of the hook for stabilizing the hook on an inclined surface;
a roller rotatably connected to a rear portion hook so that the roller rolls in a direction parallel with a longitudinal axis of the plurality of pole segments;
a rung cantilevering from each pole segment;
a strap along a lateral face of each rung;
a release associated with each pole segment that moves the pole segment between a slidably engagement and a locked engagement with an adjacent pole segment; and
a foot coupled to a proximal-most pole segment of the plurality of pole segments.

10. A method of climbing an inclined roof, the method comprising:
rolling, by way of the roller, the telescoping climbing device of claim 9, in the extended condition, up the inclined roof until the hook is adjacent a ridge of the inclined roof;
rotating the telescoping climbing device approximately 180 degrees so that the hook engages the ridge; and
engaging the plurality of rungs in a climbing motion.
